(19) United States
(12) Patent Application Publication
(10) Pub. No.: US 2005/0262154 A1
(43) Pub. Date: Nov. 24, 2005

(54) Method for allocating data to a database to provide selective access and its application to geophysical data

(76) Inventor: Richard C. Cooper, Houston, TX (US)

Correspondence Address: RICHARD A. FAGIN, P.O. BOX 1247, RICHMOND, TX, 77406-1247, US

(21) Appl. No.: 10/847,957

(22) Filed: May 18, 2004

(51) Int. Cl. G06F 7/00

(52) U.S. Cl. 707/200

(57) ABSTRACT

A method for allocating access to data is disclosed. The method includes storing proprietary data in a first database accessible only by an entity designated by an owner of the proprietary data. The proprietary data are time indexed and are automatically transferred to a second database being accessible by an entity other than the designated entity at a time at which the proprietary data lose proprietary status.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The invention relates generally to the field of allocating and storing data in a database having selective, controlled access to the data by various users. More specifically, the invention relates to methods for storing geophysical data in a database such that access automatically changes upon automatic changes to rules for access of the data.

2. Background Art

Geophysical data are used to infer structures of the Earth's subsurface, the mineralogy of the Earth's subsurface, and the fluid content of pore spaces in porous subsurface Earth formations. Such inferences are typically used in the exploration for and in the exploitation of mineral resources in the Earth's subsurface, petroleum being an important one of such resources.

Geophysical data representing the Earth's subsurface are acquired in a number of different ways, depending on the type of data. Reflection seismic data, for example, are acquired by actuating a seismic energy source near the Earth's surface (or near the water surface in marine seismic surveying) at a selected location, and then detecting reflected seismic energy at a plurality of seismic receivers disposed at selected positions near the Earth's surface (or near the water surface). Inferences about the Earth's subsurface structure, its mineral composition and its fluid content are made from various attributes of the detected seismic energy. Well log data are acquired by lowering one or more instruments into wellbores drilled into the Earth. The instruments have various sensors for measuring properties of the Earth formations penetrated by the wellbore, such properties including electrical resistivity, natural gamma radiation, compressional and shear acoustic velocities, bulk density and neutron diffusion properties, among others. The one or more instruments are lowered into a wellbore at the end of a drilling tool string or armored electrical cable, and are gradually withdrawn from the wellbore while a recording is made with respect to depth in the wellbore of the measurements made by the sensors in the instrument(s). Inferences are made from well log measurements about the mineral composition, mechanical properties, fractional volume of pore space, permeability, and fluid content of the Earth formations, among other properties thereof.

An important application for well log data is to correlate the foregoing and/or other physical properties determined from well log data to various attributes of reflection seismic survey data. The significance of making such correlations is that well log data are representative of only a very small volume of the Earth's subsurface, typically within a range of two meters or less laterally from the wellbore in which the well log measurements were made. It is often impracticable, therefore, to acquire sufficient well log data to accurately interpolate the physical properties of the Earth between wellbores using only well log data. Reflection seismic survey data, by contrast, may be quickly and efficiently acquired over a substantial area of the Earth's surface. Seismic data also can have an effective measurement range such that seismic attributes may be interpolated more precisely between locations at which seismic data are acquired. Good correlation of seismic attributes to well log data thus provides the possibility of more precise interpolation of physical properties between relatively widely separated wellbores. Such more precise interpolation of properties can provide benefits such as more accurate prediction of fluid flow out of selected wellbores (related to petroleum production rates) and more precise estimates of structure of the Earth's subsurface so as to increase the probability that a wellbore drilled in a particular place and along a particular trajectory will encounter Earth formations likely to produce economically useful amounts of petroleum.

Geophysicists and others responsible for inferring the structure and composition of the Earth's subsurface make use of well log data and seismic data for interpretation and correlation as explained above. Well log data (and seismic data to some extent) may be roughly characterized in terms of their accessibility into one of two categories. First are data that are proprietary to the operator of the wellbores from which the data were acquired. Access to such proprietary data is typically limited to persons specifically authorized or designated by the well operator. Other data, specifically well log data, may be initially proprietary but eventually become accessible by the general public. Such public access to formerly proprietary data is ordinarily a result of disclosure by agencies of government, or by other rule, law or regulation requiring such public disclosure after a selected period of time. Typically, such public disclosure is performed by delivery of a set of well log data for each well subject to disclosure to an agency of government, which agency then makes copies of such data available to the public upon request. Such data are typically delivered in the same form as originally recorded, and thus do not include any form of interpretation, calibration or adjustment.

It is known in the art that well log data in so called “raw” form that are typically available from government agencies must undergo substantial processing and interpretation before they may be used for correlation to seismic data, or detailed analysis of the Earth's subsurface. Such processing includes, for example, depth corrections, corrections for the axial and lateral limits of resolution of the various well logging sensors, corrections for the properties of fluid in the wellbore at the time the data were acquired and corrections for displacement of native (connate) fluid in permeable Earth formations by the liquid phase of the fluid in the wellbore (called “filtrate invasion”), among other processing. Well log data may also be normalized for variations in instrument type, acquisition techniques and parameters and other factors. Such processing has as an objective highly consistent results when interpretation and correlation to seismic data are performed.

Normalization and preprocessing procedures may also be performed on seismic survey data. Seismic data may be proprietary to an exploration organization, or may be owned by a seismic acquisition and processing organization, which may license the seismic data in raw and/or preprocessed form to various exploration organizations.

The foregoing processing of well log data may be performed by the owner of the data where the data are proprietary, or may be performed by an organization engaged by the owner of such proprietary data. It is frequently the case that processed well log data are not accessible by the public when the raw data used to produce the processed data are eventually disclosed (the disclosure being for the reasons explained above). Thus, the public is generally not able to take advantage of the processing already performed. In other cases, a single organization may have processed a large amount of well log data from a number of different wells during the time in which such well log data were proprietary to the respective well operators, but the single organization may not be able to publish the processed data when the raw well log data are no longer proprietary. Therefore, it is frequently necessary to reprocess well log data after they have been made available to the public. Further, data made available to the public by government agency disclosure are often in optical form (paper prints and/or optical film). Such optical form data must be digitized prior to processing, thus increasing cost, reducing efficiency, and reducing accuracy.

What is needed is a system for automatically making processed well log data available to the public, as well as raw data in digital form when such is the original recording form, from an existing store of such data when the data are made available to the public.

### SUMMARY OF INVENTION

One aspect of the invention is a method for allocating access to data. The method includes storing proprietary data in a first database accessible only by an entity designated by an owner of the proprietary data. The proprietary data are time indexed and are automatically transferred to a second database being accessible by an entity other than the designated entity at a time at which the proprietary data lose proprietary status. In some embodiments, the proprietary data are preprocessed and stored in the first database. The preprocessed proprietary data may be automatically transferred to the second database when the proprietary data lose proprietary status. In some embodiments, the proprietary data include well log data. In some embodiments, the proprietary data include seismic data.

Other aspects and advantages of the invention will be apparent from the following description and the appended claims.

### BRIEF DESCRIPTION OF DRAWINGS

FIG. 1 shows a flow chart of one embodiment of a data processing method and variable access storage system according to the invention.

### DETAILED DESCRIPTION

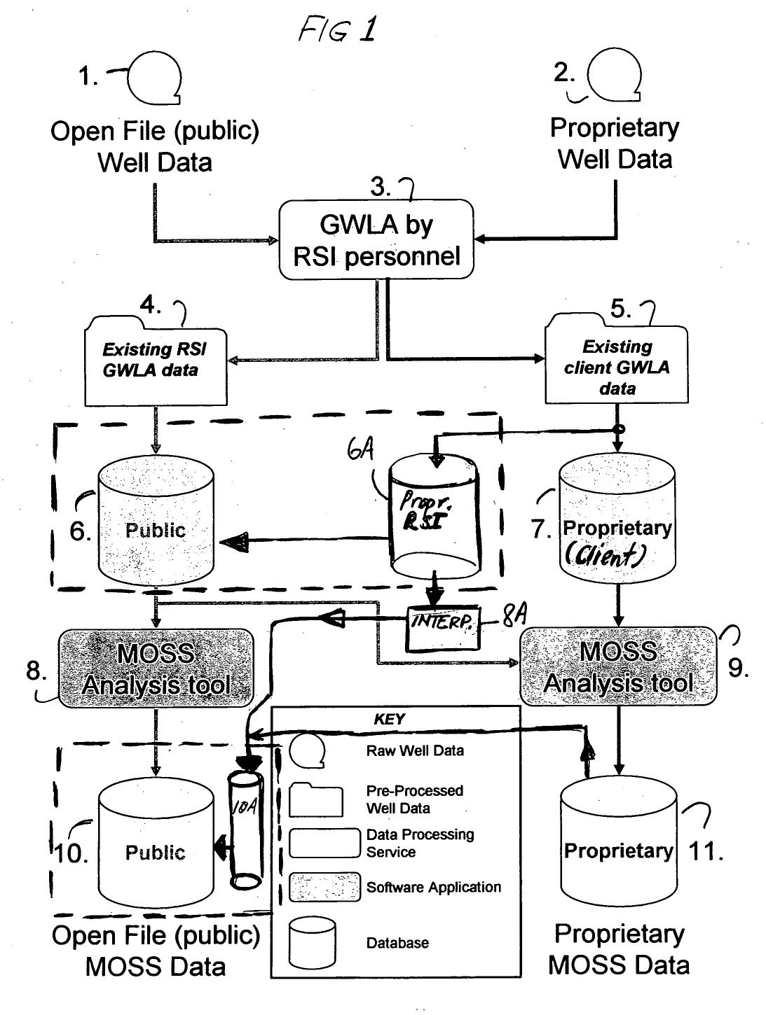

A flow chart of a system and method for processing, storing and selectively controlling access to geophysical data, such as well log data, is shown in FIG. 1. At 1, raw (unprocessed) well log data available to the general public (called “open file” data) is entered into a data preprocessing program or process at 3. As explained in the Background section herein, open file well log data initially may be proprietary to the operator of the wellbore in which the data were measured. The proprietary data become accessible by the public upon expiration of a time interval starting at the acquisition time of the well log data. The time interval is typically determined by an agency of government. For example, in wellbores drilled on outer continental shelf (OCS) leases under the jurisdiction of the United States Government, the Minerals Management Service (MMS) sets a two-year time period after acquisition of the well log data after which the wellbore operator must provide such well log data to the MMS. The MMS makes such data available to any member of the public upon request and payment of a fee. In the present embodiment, a provider of geophysical interpretation and data storage services may acquire open file data from sources such as the MMS (or corresponding agency of a State government in the United States or of any other country). The service provider may also acquire data from wellbore operators when such data are no longer proprietary or should the well operator no longer desire to prevent disclosure of particular well log data to the public.

Preprocessing 3 may include normalization, depth correction, environmental correction, filtrate invasion correction, and other process elements known in the art to assure that the preprocessed well log data provide substantially the same value of measurement for the same physical parameters being measured. In cases where the raw well log data 1 are obtained in optical format, such as a paper print, the preprocessing 3 may include digitization of the optical format data. One preprocessing procedure is sold under the trade name “GEOPHYSICAL WELL LOG ANALYSIS” (GWLA) by Rock Solid Images, Houston, Tex. The term “preprocessing” as used herein is thus intended to include any data processing procedure to correct geophysical data such that the data have the same value for measurements which correspond to the same value of a measured physical parameter. The GWLA process is only one example of such preprocessing procedures and is not intended to limit the scope of preprocessing useful with the invention.

The preprocessed, open file data 4 may then be stored in a publicly accessible database 6 operated, owned and/or otherwise controlled by the provider of preprocessing services. It is contemplated that the provider of preprocessing services may obtain a substantial amount of open file raw well log data 1 for preprocessing and storage in the public database 6. The public database 6 may be accessed by selected subscribers or users without control relating to the proprietary nature of the well log data because all such well log data are otherwise accessible to the public. It is contemplated that access to the public database 6 will be provided to public subscribers by the service provider for a fee that reflects the value added by the preprocessing by the service provider. The service provider may also make the raw data available to public subscribers.

In one embodiment, the service provider may choose to perform a detailed analysis and interpretation of the preprocessed data. This is shown at 8 in FIG. 1. Such detailed analysis and interpretation process may include generation of seismic attributes, wellbore data correlation to seismic surveys, physical properties of the Earth formations, and other interpretation elements intended to improve interpolation of Earth formation properties between wellbores using seismic data. One interpretation and processing system is sold under the trade name “MOSS” by Rock Solid Images, Houston, Tex. The interpreted well log data may be stored in an interpreted well log database 10. The interpreted well log database 10 may also be accessed by subscribers without the need to control access based on the proprietary status of the data, because all the underlying raw data and preprocessed data are publicly available. As used herein, the term “detailed analysis and interpretation” is intended to include any process for geophysical data which generates any inference about subsurface Earth structure, composition of subsurface Earth formations, fluid content and fluid mobility of subsurface Earth formations from measurements of one or more physical parameters of the Earth's subsurface. The MOSS process described above is only one example of a detailed analysis and interpretation process and is not intended to limit the scope of such processes which may be used with the invention.

At 2, proprietary well log data may be transferred to the preprocessing service provider from the owner of such data or such owner's designated entity. For purposes of defining the invention, access to proprietary data are defined as accessible by an entity designated by the owner of the proprietary data (which designated entity may be the owner himself or any person or organization authorized by the owner). The owner of the proprietary data 2 is typically the operator of the wellbore from which such data were measured in the case of well log data. The owner may also be an entity which commissioned and paid for a proprietary seismic survey in the case of seismic data. For purpose of explaining the invention, it is assumed that the service provider is the same entity that performs storage and/or preprocessing of “open file” well log data. The service provider can perform substantially the same type of and set of preprocessing elements on the proprietary data, at 3, as are performed on the open file data 1. A resulting set of preprocessed, proprietary well log data, at 5, are then transferred to a proprietary database 7, that is owned, controlled and/or operated by the owner of the proprietary well log data 2. The owner of the proprietary, preprocessed well log data 5, may use the same or a different interpretation software tool, at 9, to generate interpreted results. The interpreted results may be stored in a database 11 owned, operated and or/controlled by the owner of the proprietary well log data 2. In the present embodiment, the software tool 9 can be the same MOSS tool as explained above. The software tool 9 may be owned and/or licensed by the owner of the proprietary well log data 2.

In the present invention, based on a subscription by the owner of the proprietary well log data to services offered by the service provider, the preprocessed proprietary data 5, and/or the raw data 2 are also stored in a proprietary database 6A owned, operated and/or controlled by the service provider. The proprietary database operated by the service provider 6A may be the same or a different physical database as the preprocessed, open file (public) database 6. The proprietary well log data are initially indexed (“time stamped”) by the service provider based on the acquisition time (and date) of the raw, proprietary well log data 2. The index indicates the beginning of a determinable time period during which the proprietary well log data 2 remain proprietary to the data owner.

After expiration of the time period (typically set by an agency of government, e.g., the MMS), the indexed, preprocessed proprietary well log data 5 and/or the raw data 2 are transferred to the open file, preprocessed well log database 6.

Alternatively, an exploration organization or other user may perform its own detailed interpretation of selected data, using the software tool shown at 9, from the public database 6. Such interpretation may use the same or a different interpretation software tool as the interpretation performed by the preprocessing service provider.

Irrespective of which data are interpreted by the owner of the proprietary data using the software tool 9, the interpreted result may be stored in a proprietary interpreted result database 11. In another embodiment, proprietary, preprocessed data stored in the service provider's proprietary database 6A may be detail interpreted using the same or different software tool, at 8A, as is used to perform detailed interpretation on the open file preprocessed well log data stored in the public database 6. The interpreted, proprietary well log data can then be stored in a proprietary, interpreted database 10A operated by the service provider. The data stored in the proprietary, interpreted database 10A includes the same type of time stamp as the data stored in the preprocessed, proprietary database 6A. Thus, upon expiration of the appropriate time interval or period, the proprietary interpreted data may be transferred to the publicly available, interpreted database 10 for access by public subscribers.

In other embodiments, the access to the “public” databases 6, 10 may be limited to particular subscribers, rather than to general, public subscribers. In other embodiments, data stored in the proprietary preprocessed 6A and proprietary interpreted 10A databases may be made accessible to selected subscribers other than the owner of the proprietary well log data prior too expiration of the time period. Such limited access may be controlled by agreement between the owner of the proprietary data and the service provider.

Methods according to the invention provide broader access to well log data when the data are no longer proprietary to the owner of the data in a way that avoids the need to make a separate determination as to the proprietary status of the well log data, and without the need to obtain optical form data from agencies charged with their distribution. Other possible benefits of methods according to the invention include application of identical preprocessing and interpretation procedures to more well log data so as to improve the accuracy of interpretation and interpolation of physical properties between wells, and easier public access to disclosed well log data and preprocessed well log data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for allocating access to data, comprising:
storing proprietary data in a first database accessible only by an entity designated by an owner of the proprietary data;
time indexing the proprietary data; and
automatically transferring the proprietary data to a second database being accessible by an entity other than the designated entity at a time at which the proprietary data lose proprietary status.

2. The method of claim 1 further comprising preprocessing the proprietary data, storing the preprocessed proprietary data in the first database, and automatically transferring the preprocessed proprietary data at the time at which the proprietary data lose proprietary status.

3. The method of claim 2 further comprising performing a detailed interpretation on the preprocessed data prior to the time at which the proprietary data lose proprietary status, and storing the detail interpreted data in a third, proprietary, interpreted database.

4. The method of claim 3 wherein the detail interpreted database is accessible by an entity other than an owner of the proprietary data at the time at which the proprietary data lose proprietary status.

5. The method of claim 1 wherein the time at which the data lose the proprietary status is referenced to an acquisition time of the proprietary data and the time index references the acquisition time.

6. The method of claim 5 wherein a time interval between the acquisition time and the time at which the proprietary status is lost is determined by an agency of government.

7. The method of claim 1 wherein the proprietary data comprise seismic survey data.

8. The method of claim 1 wherein the proprietary data comprise well log data.

9. The method of claim 1 wherein the second database is publicly accessible.

10. The method of claim 1 wherein the second database is accessible only by subscribers thereto.

11. A method for allocating access to geophysical well log data, comprising:
storing proprietary geophysical well log data in a first database accessible only by an entity designated by an owner of the proprietary geophysical well log data;
time indexing the proprietary geophysical well log data; and
automatically transferring the proprietary geophysical well log data to a second database being accessible by an entity other than the designated entity at a time at which the proprietary geophysical well log data lose proprietary status.

12. The method of claim 11 further comprising preprocessing the proprietary geophysical well log data, storing the preprocessed proprietary data in the first database, and automatically transferring the preprocessed proprietary data at the time at which the proprietary data lose proprietary status.

13. The method of claim 12 further comprising performing a detailed interpretation on the preprocessed data prior to the time at which the proprietary data lose proprietary status, and storing the detail interpreted data in a third, proprietary, interpreted database.

14. The method of claim 13 wherein the detail interpreted database is accessible by an entity other than an owner of the proprietary data at the time at which the proprietary data lose proprietary status.

15. The method of claim 11 wherein the time at which the data lose the proprietary status is referenced to an acquisition time of the proprietary data and the time index references the acquisition time.

16. The method of claim 15 wherein a time internal between the acquisition time and the time at which the proprietary status is lost is determined by an agency of government.

17. The method of claim 11 wherein the second database is publicly accessible.

18. The method of claim 11 wherein the second database is accessible only by subscribers thereto.

19. The method of claim 11 wherein data stored in the first data base include proprietary seismic data, and wherein the proprietary seismic data are time indexed and are automatically transferred to the second database at a time at which the proprietary status of the seismic data lose proprietary status.

20. A method for allocating access to seismic data, comprising:
storing proprietary seismic data in a first database accessible only by an entity designated by an owner of the proprietary seismic data;
time indexing the proprietary seismic data; and
automatically transferring the proprietary seismic data to a second database being accessible by an entity other than the designated entity at a time at which the proprietary seismic data lose proprietary status.

21. The method of claim 20 wherein the time at which the data lose the proprietary status is referenced to an acquisition time of the proprietary data and the time index references the acquisition time.

22. The method of claim 21 wherein a time interval between the acquisition time and the time at which the proprietary status is lost is determined by an agency of government.

23. The method of claim 20 wherein the second database is publicly accessible.

24. The method of claim 20 wherein the second database is accessible only by subscribers thereto.
